(19) United States
(12) Patent Application Publication
(10) Pub. No.: US 2024/0405960 A1
(43) Pub. Date: Dec. 5, 2024

(54) TRANSMISSION CONFIGURATION INDICATOR STATE CARRIER CONFIGURATION

(71) Applicant: LENOVO (BEIJING) LIMITED, Beijing (CN)

(72) Inventors: Chenxi Zhu, Beijing (CN); Bingchao Liu, Beijing (CN); Yi Zhang, Beijing (CN); Wei Ling, Beijing (CN); Lingling Xiao, Beijing (CN)

(21) Appl. No.: 18/699,513

(22) PCT Filed: Oct. 8, 2021
(86) PCT No.: PCT/CN2021/122604

§ 371 Date: Apr. 8, 2024

(51) Int. Cl. H04L 5/00; H04W 72/231

(52) U.S. Cl. CPC H04L 5/0098; H04L 5/0053; H04W 72/231

(57) ABSTRACT

Apparatuses, methods, and systems are disclosed for transmission configuration indicator state carrier configuration. One method (1000) includes receiving (1002) RRC messages to configure a TCI state pool in a PDSCH-configuration in a BWP and/or a CC. The TCI state pool includes multiple TCI states, the multiple TCI states are configured for use in a list of carriers that includes a list of QCL-TypeA resources, and each QCL-TypeA resource includes a RS defined in a carrier of a list of carriers. The method (1000) includes receiving (1004) a MAC CE message that activates a subset of the plurality of transmission TCI for use. The method (1000) includes receiving (1006) a DCI signal that indicates a TCI state of the plurality of TCI states for a PDSCH, a PDCCH, a PUSCH, and/or a PUCCH in a selected BWP and/or a selected CC.

### FIELD

The subject matter disclosed herein relates generally to wireless communications and more particularly relates to transmission configuration indicator state carrier configuration.

### BACKGROUND

In certain wireless communications networks, transmission configuration states may be limited. In such networks, functionality of devices may be limited.

### BRIEF SUMMARY

Methods for transmission configuration indicator state carrier configuration are disclosed. Apparatuses and systems also perform the functions of the methods. In one embodiment, the method includes receiving, at a user equipment, radio resource configuration messages to configure a transmission configuration indicator state pool in a physical downlink shared channel-configuration in a bandwidth part, a component carrier, or a combination thereof. The transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers. In certain embodiments, the method includes receiving a medium access control control element message that activates a subset of the plurality of transmission configuration indicator states for use. In some embodiments, the method includes receiving a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

An apparatus for transmission configuration indicator state carrier configuration, in one embodiment, includes a user equipment. In some embodiments, the apparatus includes a receiver that: receives radio resource configuration messages to configure a transmission configuration indicator state pool in a physical downlink shared channel-configuration in a bandwidth part, a component carrier, or a combination thereof, wherein the transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers; receives a medium access control control element message that activates a subset of the plurality of transmission configuration indicator states for use; and receives a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

In another embodiment, a method for transmission configuration indicator state carrier configuration includes transmitting, from a network device, radio resource configuration messages to configure a transmission configuration indicator state pool in a physical downlink shared channel-configuration in a bandwidth part, a component carrier, or a combination thereof. The transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers. In certain embodiments, the method includes transmitting a medium access control control element message that activates a subset of the plurality of transmission configuration indicator states for use. In some embodiments, the method includes transmitting a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

Another apparatus for transmission configuration indicator state carrier configuration, in one embodiment, includes a network device. In some embodiments, the apparatus includes a transmitter that: transmits radio resource configuration messages to configure a transmission configuration indicator state pool in a physical downlink shared channel-configuration in a bandwidth part, a component carrier, or a combination thereof, wherein the transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers; transmits a medium access control control element message that activates a subset of the plurality of transmission configuration indicator states for use; and transmits a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for transmission configuration indicator state carrier configuration;

FIG. 2 is a schematic block diagram illustrating one embodiment of an apparatus that may be used for transmission configuration indicator state carrier configuration;

FIG. 3 is a schematic block diagram illustrating another embodiment of an apparatus that may be used for transmission configuration indicator state carrier configuration;

FIG. 4 illustrates code representing one embodiment of a DL TCI state;

FIG. 5 illustrates code representing another embodiment of a DL TCI state;

FIG. 6 illustrates code representing one embodiment of a DL and an UL TCI state;

FIG. 7 illustrates code representing another embodiment of a DL and an UL TCI state;

FIG. 8 illustrates code representing a further embodiment of a TCI state;

FIG. 9 illustrates code representing yet another embodiment of a TCI state;

FIG. 10 is a schematic flow chart diagram illustrating one embodiment of a method for transmission configuration indicator state carrier configuration; and

FIG. 11 is a schematic flow chart diagram illustrating another embodiment of a method for transmission configuration indicator state carrier configuration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

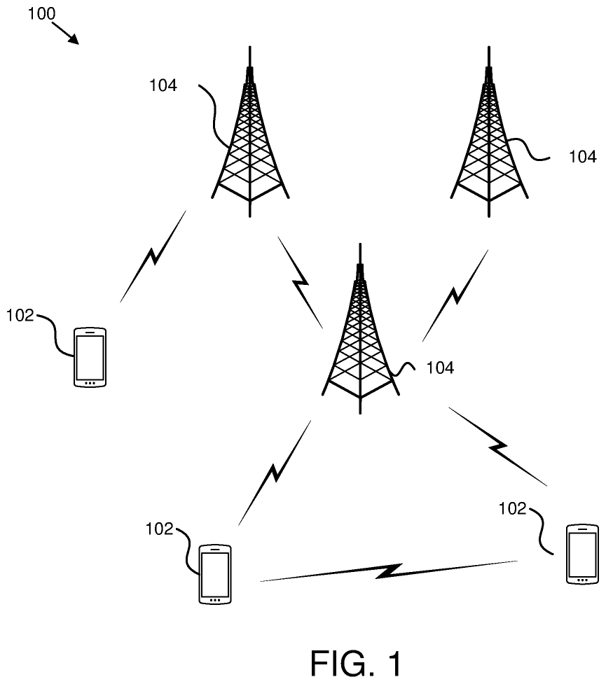

FIG. 1 depicts an embodiment of a wireless communication system 100 for transmission configuration indicator state carrier configuration. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNodeB (“gNB”), a Home Node-B, a RAN, a relay node, a device, a network device, an integrated and access backhaul (“IAB”) node, a donor IAB node, a controller, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the third generation partnership program (“3GPP”) protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit downlink (“DL”) communication signals to serve the remote units 102 in the time, frequency, and/or spatial domain.

In various embodiments, a remote unit 102 may receive radio resource configuration messages to configure a transmission configuration indicator state pool in a physical downlink shared channel-configuration in a bandwidth part, a component carrier, or a combination thereof. The transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers. In certain embodiments, the remote unit 102 may receive a medium access control control element message that activates a subset of the plurality of transmission configuration indicator states for use. In some embodiments, the remote unit 102 may receive a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof. Accordingly, a remote unit 102 may be used for transmission configuration indicator state carrier configuration.

In certain embodiments, a network unit 104 may transmit radio resource configuration messages to configure a transmission configuration indicator state pool in a physical downlink shared channel-configuration in a bandwidth part, a component carrier, or a combination thereof. The transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers. In certain embodiments, the network unit 104 may transmit a medium access control control element message that activates a subset of the plurality of transmission configuration indicator states for use. In some embodiments, the network unit 104 may transmit a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof. Accordingly, a network unit 104 may be used for transmission configuration indicator state carrier configuration.

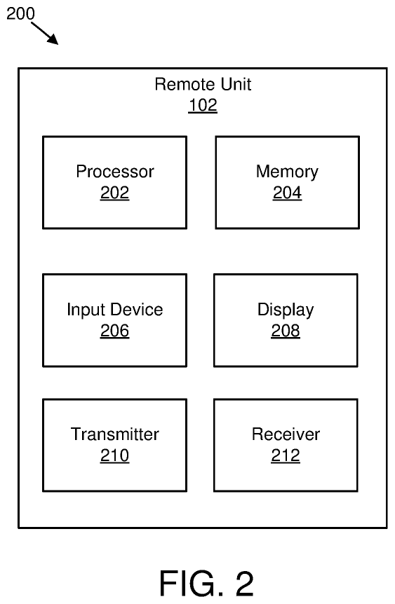

FIG. 2 depicts one embodiment of an apparatus 200 that may be used for transmission configuration indicator state carrier configuration. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”) display, an LED display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In some embodiments, the receiver 212: receives radio resource configuration messages to configure a transmission configuration indicator state pool in a physical downlink shared channel-configuration in a bandwidth part, a component carrier, or a combination thereof, wherein the transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers; receives a medium access control control element message that activates a subset of the plurality of transmission configuration indicator states for use; and receives a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

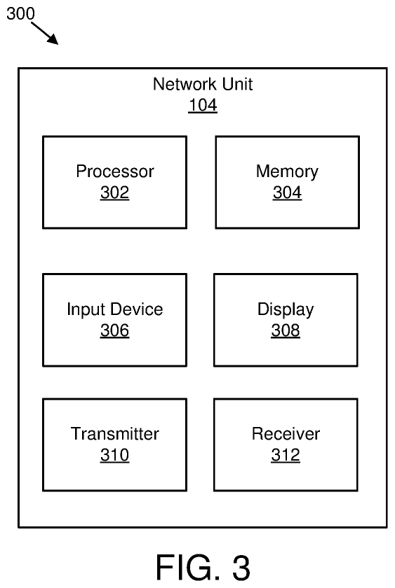

FIG. 3 depicts another embodiment of an apparatus 300 that may be used for transmission configuration indicator state carrier configuration. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the transmitter 310: transmits radio resource configuration messages to configure a transmission configuration indicator state pool in a physical downlink shared channel-configuration in a bandwidth part, a component carrier, or a combination thereof, wherein the transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers; transmits a medium access control control element message that activates a subset of the plurality of transmission configuration indicator states for use; and transmits a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, a transmission configuration indicator (“TCI”) state may represent a downlink (“DL”) TCI, an uplink (“UL”) TCI, or a joint TCI. A TCI state pool may be configured, and may include a separate DL TCI state, an UL TCI state, or joint DL and UL TCI state indicated by a TCI field in a downlink control information (“DCI”) format (e.g., DCI format 1_1 and/or DCI format 1_2) with or without a physical downlink shared channel (“PDSCH”) assignment may be used to update a common TCI state for the PDSCH, a physical downlink control channel (“PDCCH”), a physical uplink shared channel (“PUSCH”), and/or a physical uplink control channel (“PUCCH”), and some DL and UL reference signals (“RSs”) sharing the same TCI state with the DL and/or UL channels. A radio resource control (“RRC”) configured TCI state pool may be present or absent in a bandwidth part (“BWP”) and/or component carrier (“CC”). If RRC-configured TCI state pools are absent in the PDSCH configuration (e.g., PDSCH-Config) for a BWP and/or CC, another TCI state pool configured in a reference BWP and/or CC is used in its place. For a BWP and/or CC, where the PDSCH configuration contains a reference to the RRC-configured TCI state pools in a reference BWP and/or CC, a UE applies the RRC-configured TCI state pools in the reference BWP and/or CC.

In some embodiments, a TCI state contains a quasi-co-location (“QCL”) type (“QCL-Type”) of A (“QCL-TypeA”), B (“QCL-TypeB”), or C (“QCL-TypeC”), and a QCL-Type D (“QCL-TypeD”) if applicable. A QCL-Type D may be shared across multiple CCs in the same band to provide spatial receive (“RX”) parameters for a UE to receive DL a channel and/or a signal in the CC. However, a QCL-Type A may need to be in the same CC that it is applied to. This may become an issue if a TCI state can be used in another CC in the same band. In various embodiments, TCI states may be configured for sharing across CC so a BWP and/or a CC has a correct reference for QCL-TypeA and QCL-TypeD.

In certain embodiments, a TCI state may be configured to provide references across multiple carriers. This may include one or more TCI states that are DL-only, joint DL and UL, and/or separate DL and UL. For any TCI state, a QCL-TypeA reference may provide a reference for DL reception including Doppler shift, Doppler spread, average delay, and/or delay spread, and an additional QCL-TypeD may provide a spatial RX parameter for reception of DL signals and channels.

In some embodiments, for a DL carrier, a UE may have a QCL-TypeD that belongs to another carrier in the same band to provide a spatial RX parameter, and a QCL-TypeA that belongs to the same carrier to provide a parameter for Doppler shift, Doppler spread, average delay, and/or delay spread. If a TCI state is used in multiple carriers in a carrier list in the same band, to provide QCL-TypeA and QCL-TypeD references to each DL carrier, it may be configured with a single QCL-TypeD as a spatial RX parameter for all the carriers, and multiple QCL-TypeAs (e.g., one for each carrier in the carrier list sharing the TCI states). If applying the TCI state to carrier c, the UE applies the QCL-TypeA defined in carrier c (e.g., which has the reference signal defined as QCL-TypeA in carrier c), and the QCL-TypeD may be defined in another carrier. The multiple QCL-TypeAs may only affect DL. If the same TCI includes a spatial transmit (“TX”) reference to an UL carrier (e.g., either as a dedicated UL TX beam reference in a QCL type F (“QCL-TypeF”) in a separate DL and/or UL TCI state, or a shared spatial reference for both DL and UL as QCL type E (“QCL-TypeE”) in a joint DL and UL TCI state), the single UL spatial filter derived from QCL-TypeE or QCL-TypeF may be applied to all UL carriers, but no reference may be made to any of the QCL-TypeAs for the UL carrier.

In various embodiments, if a TCI state is applied to a UE specific PDSCH and/or PDCCH (and possibly to UE specific PUSCH and/or PUCCH), QCL-TypeA is always required, and a QCL-TypeA RS may be a channel state information (“CSI”) RS (“CSI-RS”) resource in a non-zero power (“NZP”) CSI-RS resource set (“NZP-CSI-RS-ResourceSet”) configured with a higher layer parameter trs-info (e.g., as a tracking RS (“TRS”)). In certain embodiments, a QCL-TypeD, a QCL-TypeE, and/or a QCL-TypeF is only included if a network also indicates a DL RX beam or an UL TX beam for a UE. The QCL-TypeD and/or the QCL-TypeE RS may be a CSI-RS resource in an NZP-CSI-RS-ResourceSet configured with high layer parameter repetition. If a QCL-TypeF is included, a QCL-TypeF RS may be separate from QCL-TypeA, QCL-TypeD, and/or QCL-TypeE, and may be a synchronization signal block (“SSB”), CSI-RS, or sounding reference signal (“SRS”) in the same or another CC.

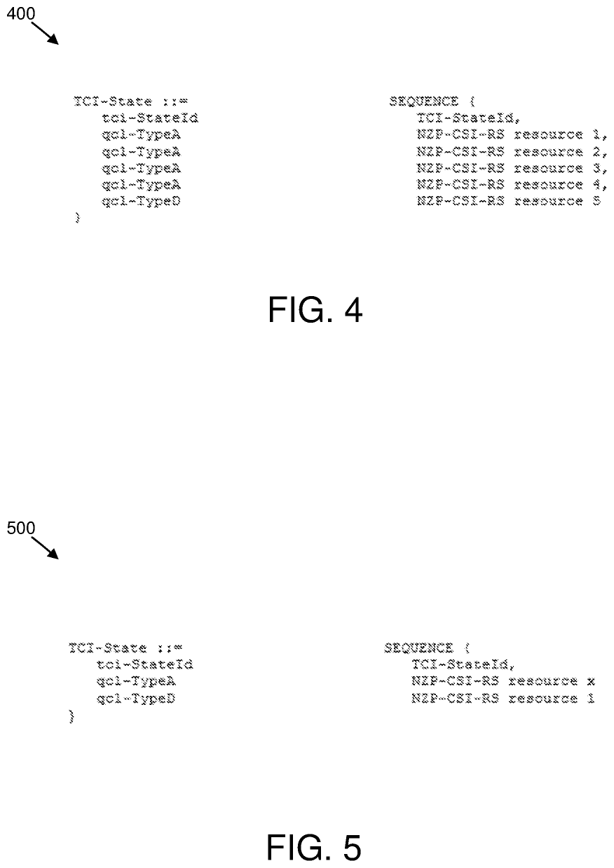

In a first embodiment, a list of carriers includes 4 CCs (e.g., CC1 through CC4) in the same band, where NZP-CSI-RS resource 1, 2, 3, and 4 are NZP-CSI-RS resources with parameter trs-info defined in CC1, CC2, CC3, and CC4 respectively. An NZP-CSI-RS resource may be identified by: an NZP-CIS-RS resource identifier (“ID”) and a CC index. An NZP-CSI-RS 5 resource is a CSI-RS resource in an NZP-CSI-RS resource set configured with RRC parameter repetition defined in CC1. A DL TCI state may be defined as shown in FIG. 4. Specifically, FIG. 4 illustrates code 400 representing one embodiment of a DL TCI state according to the first embodiment.

In the first embodiment, a single QCL-TypeD NZP-CSI-RS resource 5 may be defined in CC1 and may provide a common spatial RX parameter for CC1, CC2, CC3, and CC4. For QCL-TypeA, the UE applies an NZP-CSI-RS resource 1, 2, 3, and 4 for CC1, CC2, CC3, and 4 respectively. If a common TCI state is applied to a CC (e.g., a BWP or multiple BWPs of the CC), the effective TCI state applied to CC x (e.g., x=1, 2, 3, 4) as shown in FIG. 5, where NZP-CSI-RS resource x is the QCL-TypeA RS defined in CC x (e.g., may be in BWP other than the BWP it applies to). Specifically, FIG. 5 illustrates code 500 representing another embodiment of a DL TCI state according to the first embodiment.

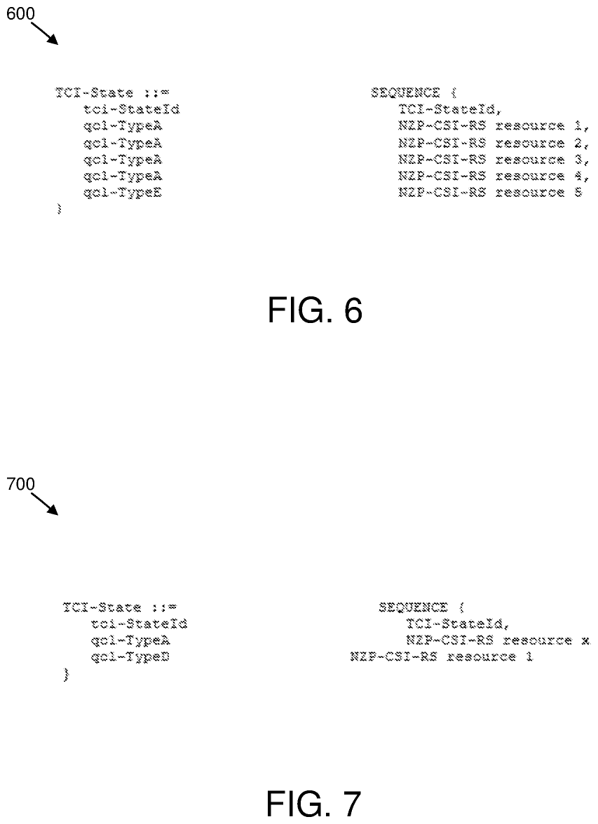

In a second embodiment, a same carrier configuration and RS definition may be used as found in the first embodiment, but it may be used for a joint DL and an UL TCI state as shown in FIG. 6. Specifically, FIG. 6 illustrates code 600 representing one embodiment of a DL and an UL TCI state according to the second embodiment. Here, a QCL-TypeE RS may be used both as a QCL-TypeD RS in the DL to provide a spatial RX parameter, and as spatial relation information in the UL to provide an UL TX beam (e.g., TX spatial parameter). In DL, if the TCI state is applied to a CC x (e.g., x=1, 2, 3, 4) such as via a BWP or multiple BWPs of the CC x, a UE may apply a TCI state as shown in FIG. 7. Specifically, FIG. 7 illustrates code 700 representing another embodiment of a DL and an UL TCI state according to the second embodiment. In FIG. 7, an NZP-CSI-RS resource x is a QCL-TypeA RS defined in CC x (e.g., may be in a BWP other than the BWP it applies to) to provide reference to Doppler shift, Doppler spread, average delay, and/or delay spread, and the QCL-TypeE RS (e.g., NZP-CSI-RS resource 5 defined in one of the CCs or another CC in the same band) provides a spatial TX filter parameter to the UL in CC1, CC2, CC3, and CC4. The UE applies the QCL-TypeE RS (e.g., NZP-CSI-RS resource 5) as a spatial TX filter parameter to the UL in CC1, CC2, CC3, and CC4.

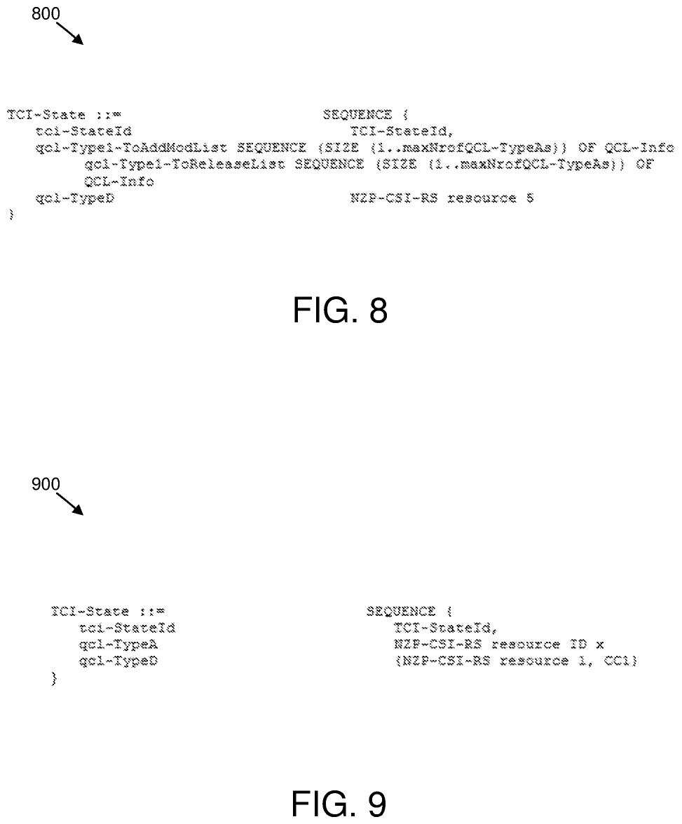

In a third embodiment, a same carrier configuration and RS definition may be used as found in the first embodiment, except that the QCL-TypeAs are configured as a sequence as shown in FIG. 8. Specifically, FIG. 8 illustrates code 800 representing a further embodiment of a TCI state according to the third embodiment. In FIG. 8, maxNrofQCL-TypeAs is an RRC parameter indicate a maximum number of QCL-TypeAs that can be configured in a TCI state. This is the same as the maximum number of CCs in a list that can share the TCI states. It may be part of UE's capability.

In a fourth embodiment, another way to configure multiple QCL-TypeAs in a TCI state is to only specify a single NZP-CSI-RS resource ID (e.g., nzp-csi-resource-id) for the RS without a CC index. The NZP-CSI-RS resource with this resource ID may be used in every CC in a list of CCs for sharing the TCI states as QCL-TypeA in the individual CC. Such a TCI state may be configured as shown in FIG. 9. Specifically, FIG. 9 illustrates code 900 representing yet another embodiment of a TCI state according to the fourth embodiment. If the TCI state is applied to carrier c of a list of carriers, an NZP-CSI-RS resource ID x and a carrier c may be used as QCL-TypeA, and an NZP-CSI-RS resource 1 and a CC1 may be used as QCL-TypeD.

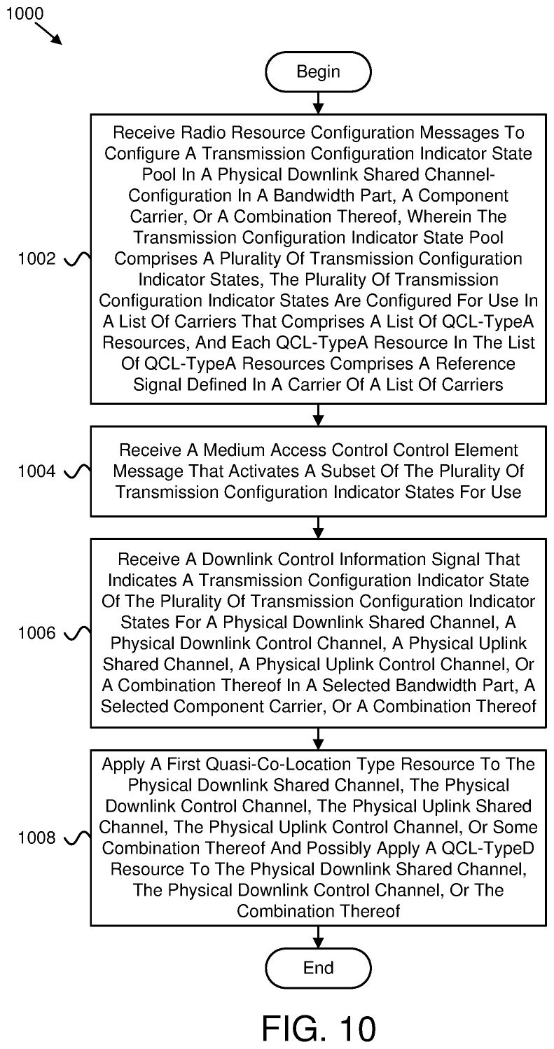

FIG. 10 is a schematic flow chart diagram illustrating one embodiment of a method 1000 for transmission configuration indicator state carrier configuration. In some embodiments, the method 1000 is performed by an apparatus, such as the remote unit 102. In certain embodiments, the method 1000 may be performed by a processor executing program code, for example, a microcontroller, a microprocessor, a CPU, a GPU, an auxiliary processing unit, a FPGA, or the like.

The method 1000 may include receiving 1002 radio resource configuration messages to configure a transmission configuration indicator state pool in a physical downlink shared channel-configuration in a bandwidth part, a component carrier, or a combination thereof. The transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers. In certain embodiments, the method 1000 includes receiving 1004 a medium access control control element message that activates a subset of the plurality of transmission configuration indicator states for use. In some embodiments, the method 1000 includes receiving 1006 a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

In certain embodiments, the method 100 includes applying 1008 a first quasi-co-location type resource to the physical downlink shared channel, the physical downlink control channel, the physical uplink shared channel, the physical uplink control channel, or some combination thereof, and possibly applying a QCL-TypeD resource to the physical downlink shared channel, the physical downlink control channel, or the combination thereof. In some embodiments, the QCL-TypeA resource comprises a non-zero power channel state information reference signal resource. In various embodiments, the non-zero power channel state information reference signal resource is in a non-zero power channel state information reference signal resource set configured by a high layer parameter trs-info.

In one embodiment, the method 1000 further comprises, in response to the transmission configuration indicator being applied for the component carrier, applying the QCL-TypeD resource or the first quasi-co-location type resource defined in the component carrier as spatial receive information for downlink reception in the component carrier. In certain embodiments, the method 1000 further comprises applying the QCL-TypeD resource or the first quasi-co-location type resource as a spatial receive parameter in the component carrier even if the QCL-TypeD resource or the first quasi-co-location type resource is not defined in the component carrier.

In some embodiments, the transmission configuration indicator state comprises a second quasi-co-location type resource. In various embodiments, the method 1000 further comprises, in response to the transmission configuration indicator being applied for the component carrier, applying the second quasi-co-location type resource to the physical uplink shared channel, the physical uplink control channel, or a combination thereof as a spatial transmit transmission parameter even if the second quasi-co-location type resource is not defined in the component carrier it is applied to.

In one embodiment, the method 1000 further comprises, in response to the transmission configuration indicator being applied for the component carrier, applying the QCL-TypeA resource that has a reference signal defined in the component carrier as a reference for Doppler shift, Doppler spread, average delay, delay spread, or some combination thereof. In certain embodiments, the list of QCL-TypeA resources comprises a list of non-zero power channel state information reference signal resources with the same non-zero power channel state information reference signal resource identifier in the list of carriers. In some embodiments, the list of carriers is defined by radio resource configuration.

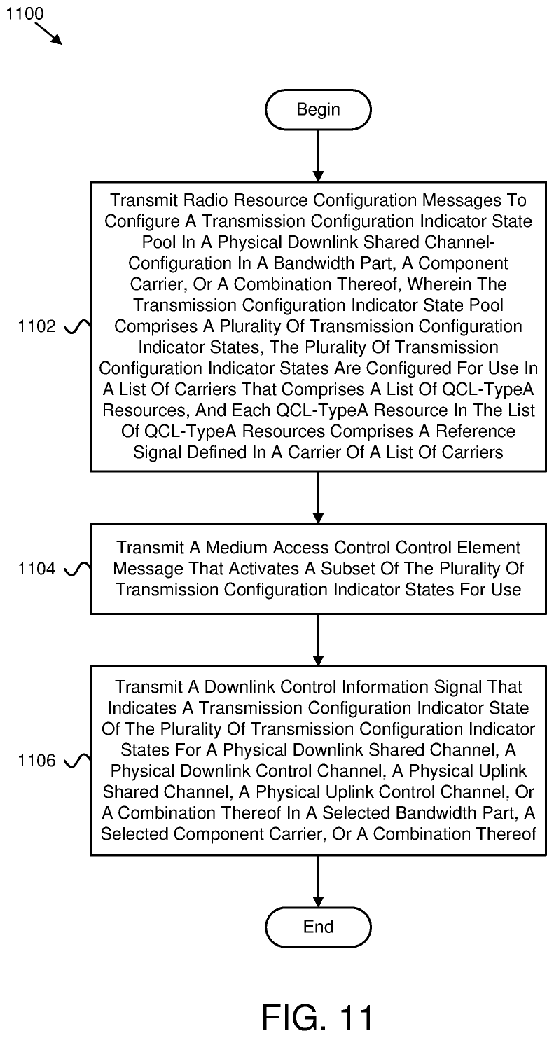

FIG. 11 is a schematic flow chart diagram illustrating one embodiment of a method 1100 for transmission configuration indicator state carrier configuration. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

The method 1100 may include transmitting 1102 radio resource configuration messages to configure a transmission configuration indicator state pool in a physical downlink shared channel-configuration in a bandwidth part, a component carrier, or a combination thereof. The transmission configuration indicator state pool includes a plurality of transmission configuration indicator states, the plurality of transmission configuration indicator states are configured for use in a list of carriers that includes a list of QCL-TypeA resources, and each QCL-TypeA resource in the list of QCL-TypeA resources includes a reference signal defined in a carrier of a list of carriers. In certain embodiments, the method 1100 includes transmitting 1104 a medium access control control element message that activates a subset of the plurality of transmission configuration indicator states for use. In some embodiments, the method 1100 includes transmitting 1106 a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

In certain embodiments, the transmission configuration indicator state comprises: a QCL-TypeD resource applied to the physical downlink shared channel, the physical downlink control channel, or the combination thereof; or a first quasi-co-location type resource applied to the physical downlink shared channel, the physical downlink control channel, the physical uplink shared channel, the physical uplink control channel, or some combination thereof. In some embodiments, the QCL-TypeA resource comprises a non-zero power channel state information reference signal resource. In various embodiments, the non-zero power channel state information reference signal resource is in a non-zero power channel state information reference signal resource set configured by a high layer parameter trs-info.

In one embodiment, the transmission configuration indicator state comprises a second quasi-co-location type resource. In certain embodiments, the list of QCL-TypeA resources comprises a list of non-zero power channel state information reference signal resources with the same non-zero power channel state information reference signal resource identifier in the list of carriers. In some embodiments, the list of carriers is defined by radio resource configuration.

In one embodiment, a method of a user equipment comprises: receiving radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers; receiving a medium access control control element message that activates a subset of the plurality of transmission configuration indicator states for use; and receiving a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

In certain embodiments, the transmission configuration indicator state comprises: a QCL-TypeD resource applied to the physical downlink shared channel, the physical downlink control channel, or the combination thereof; or a first quasi-co-location type resource applied to the physical downlink shared channel, the physical downlink control channel, the physical uplink shared channel, the physical uplink control channel, or some combination thereof.

In some embodiments, the QCL-TypeA resource comprises a non-zero power channel state information reference signal resource.

In various embodiments, the non-zero power channel state information reference signal resource is in a non-zero power channel state information reference signal resource set configured by a high layer parameter trs-info.

In one embodiment, the method further comprises, in response to the transmission configuration indicator being applied for the component carrier, applying the QCL-TypeD resource or the first quasi-co-location type resource defined in the component carrier as spatial receive information for downlink reception in the component carrier.

In certain embodiments, the method further comprises applying the QCL-TypeD resource or the first quasi-co-location type resource as a spatial receive parameter in the component carrier even if the QCL-TypeD resource or the first quasi-co-location type resource is not defined in the component carrier.

In some embodiments, the transmission configuration indicator state comprises a second quasi-co-location type resource.

In various embodiments, the method further comprises, in response to the transmission configuration indicator being applied for the component carrier, applying the second quasi-co-location type resource to the physical uplink shared channel, the physical uplink control channel, or a combination thereof as a spatial transmit transmission parameter even if the second quasi-co-location type resource is not defined in the component carrier it is applied to.

In one embodiment, the method further comprises, in response to the transmission configuration indicator being applied for the component carrier, applying the QCL-TypeA resource that has a reference signal defined in the component carrier as a reference for Doppler shift, Doppler spread, average delay, delay spread, or some combination thereof.

In certain embodiments, the list of QCL-TypeA resources comprises a list of non-zero power channel state information reference signal resources with the same non-zero power channel state information reference signal resource identifier in the list of carriers.

In some embodiments, the list of carriers is defined by radio resource configuration.

In one embodiment, an apparatus comprises a user equipment. The apparatus further comprises: a receiver that: receives radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers; receives a medium access control control element message that activates a subset of the plurality of transmission configuration indicator states for use; and receives a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

In certain embodiments, the transmission configuration indicator state comprises: a QCL-TypeD resource applied to the physical downlink shared channel, the physical downlink control channel, or the combination thereof; or a first quasi-co-location type resource applied to the physical downlink shared channel, the physical downlink control channel, the physical uplink shared channel, the physical uplink control channel, or some combination thereof.

In some embodiments, the QCL-TypeA resource comprises a non-zero power channel state information reference signal resource.

In various embodiments, the non-zero power channel state information reference signal resource is in a non-zero power channel state information reference signal resource set configured by a high layer parameter trs-info.

In one embodiment, the apparatus further comprises a processor that, in response to the transmission configuration indicator being applied for the component carrier, applies the QCL-TypeD resource or the first quasi-co-location type resource defined in the component carrier as spatial receive information for downlink reception in the component carrier.

In certain embodiments, the apparatus further comprises a processor that applies the QCL-TypeD resource or the first quasi-co-location type resource as a spatial receive parameter in the component carrier even if the QCL-TypeD resource or the first quasi-co-location type resource is not defined in the component carrier.

In some embodiments, the transmission configuration indicator state comprises a second quasi-co-location type resource.

In various embodiments, the apparatus further comprises a processor that, in response to the transmission configuration indicator being applied for the component carrier, applies the second quasi-co-location type resource to the physical uplink shared channel, the physical uplink control channel, or a combination thereof as a spatial transmit transmission parameter even if the second quasi-co-location type resource is not defined in the component carrier it is applied to.

In one embodiment, the apparatus further comprises a processor that, in response to the transmission configuration indicator being applied for the component carrier, applies the QCL-TypeA resource that has a reference signal defined in the component carrier as a reference for Doppler shift, Doppler spread, average delay, delay spread, or some combination thereof.

In certain embodiments, the list of QCL-TypeA resources comprises a list of non-zero power channel state information reference signal resources with the same non-zero power channel state information reference signal resource identifier in the list of carriers.

In some embodiments, the list of carriers is defined by radio resource configuration.

In one embodiment, a method of a network device comprises: transmitting radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers; transmitting a medium access control control element message that activates a subset of the plurality of transmission configuration indicator states for use; and transmitting a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

In certain embodiments, the transmission configuration indicator state comprises: a QCL-TypeD resource applied to the physical downlink shared channel, the physical downlink control channel, or the combination thereof; or a first quasi-co-location type resource applied to the physical downlink shared channel, the physical downlink control channel, the physical uplink shared channel, the physical uplink control channel, or some combination thereof.

In some embodiments, the QCL-TypeA resource comprises a non-zero power channel state information reference signal resource.

In various embodiments, the non-zero power channel state information reference signal resource is in a non-zero power channel state information reference signal resource set configured by a high layer parameter trs-info.

In one embodiment, the transmission configuration indicator state comprises a second quasi-co-location type resource.

In certain embodiments, the list of QCL-TypeA resources comprises a list of non-zero power channel state information reference signal resources with the same non-zero power channel state information reference signal resource identifier in the list of carriers.

In some embodiments, the list of carriers is defined by radio resource configuration.

In one embodiment, an apparatus comprises a network device. The apparatus further comprises: a transmitter that: transmits radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers; transmits a medium access control control element message that activates a subset of the plurality of transmission configuration indicator states for use; and transmits a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

In certain embodiments, the transmission configuration indicator state comprises: a QCL-TypeD resource applied to the physical downlink shared channel, the physical downlink control channel, or the combination thereof; or a first quasi-co-location type resource applied to the physical downlink shared channel, the physical downlink control channel, the physical uplink shared channel, the physical uplink control channel, or some combination thereof.

In some embodiments, the QCL-TypeA resource comprises a non-zero power channel state information reference signal resource.

In various embodiments, the non-zero power channel state information reference signal resource is in a non-zero power channel state information reference signal resource set configured by a high layer parameter trs-info.

In one embodiment, the transmission configuration indicator state comprises a second quasi-co-location type resource.

In certain embodiments, the list of QCL-TypeA resources comprises a list of non-zero power channel state information reference signal resources with the same non-zero power channel state information reference signal resource identifier in the list of carriers.

In some embodiments, the list of carriers is defined by radio resource configuration.

Embodiments may be practiced in other specific forms. One or more of the embodiments described herein may be combined to form another embodiment. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method at a user equipment (UE), the method comprising:
receiving radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers;
receiving a medium access control control element message that activates a subset of the plurality of transmission configuration indicator states for use; and
receiving a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

2. A user equipment (UE), comprising:
at least one memory; and
at least one processor coupled with the at least one memory and configured to cause the UE to:
receive radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers;
receive a medium access control control element message that activates a subset of the plurality of transmission configuration indicator states for use; and
receive a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

3. The UE of claim 2, wherein the transmission configuration indicator state comprises:
a QCL-TypeD resource applied to the physical downlink shared channel, the physical downlink control channel, or the combination thereof; or
a first quasi-co-location type resource applied to the physical downlink shared channel, the physical downlink control channel, the physical uplink shared channel, the physical uplink control channel, or some combination thereof.

4. The UE of claim 3, wherein the QCL-TypeA resource comprises a non-zero power channel state information reference signal resource.

5. The UE of claim 4, wherein the non-zero power channel state information reference signal resource is in a non-zero power channel state information reference signal resource set configured by a high layer parameter trs-info.

6. The UE of claim 3, wherein the at least one processor is configured to cause the UE to, in response to the transmission configuration indicator being applied for the component carrier, applies apply the QCL-TypeD resource or the first quasi-co-location type resource defined in the component carrier as spatial receive information for downlink reception in the component carrier.

7. The UE of claim 3, wherein the at least one processor is configured to cause the UE to apply the QCL-TypeD resource or the first quasi-co-location type resource as a spatial receive parameter in the component carrier even if the QCL-TypeD resource or the first quasi-co-location type resource is not defined in the component carrier.

8. The UE of claim 3, wherein the transmission configuration indicator state comprises a second quasi-co-location type resource.

9. The UE of claim 8, wherein the at least one processor is configured to cause the UE to, in response to the transmission configuration indicator being applied for the component carrier, applies apply the second quasi-co-location type resource to the physical uplink shared channel, the physical uplink control channel, or a combination thereof as a spatial transmit transmission parameter even if the second quasi-co-location type resource is not defined in the component carrier it is applied to.

10. The UE of claim 2, wherein the at least one processor is configured to cause the UE to, in response to the transmission configuration indicator being applied for the component carrier, applies apply the QCL-TypeA resource that has a reference signal defined in the component carrier as a reference for Doppler shift, Doppler spread, average delay, delay spread, or some combination thereof.

11. The UE of claim 2, wherein the list of QCL-TypeA resources comprises a list of non-zero power channel state information reference signal resources with the same non-zero power channel state information reference signal resource identifier in the list of carriers.

12. The UE of claim 2, wherein the list of carriers is defined by radio resource configuration.

13. A base station, comprising:
at least one memory; and
at least one processor coupled with the at least one memory and configured to cause the base station to:
transmit radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers;
transmit a medium access control control element message that activates a subset of the plurality of transmission configuration indicator states for use; and
transmit a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

14. The base station of claim 13, wherein the transmission configuration indicator state comprises:
a QCL-TypeD resource applied to the physical downlink shared channel, the physical downlink control channel, or the combination thereof; or
a first quasi-co-location type resource applied to the physical downlink shared channel, the physical downlink control channel, the physical uplink shared channel, the physical uplink control channel, or some combination thereof.

15. The base station of claim 14, wherein the QCL-TypeA resource comprises a non-zero power channel state information reference signal resource.

16. A processor for wireless communication, comprising:
at least one controller coupled with at least one memory and configured to cause the processor to:
receive radio resource configuration messages to configure a transmission configuration indicator state pool in a physical downlink shared channel-configuration in a bandwidth part, a component carrier, or a combination thereof, wherein the transmission configuration indicator state pool comprises a plurality of transmission configuration indicator states, the plurality of transmission configuration indicator states are configured for use in a list of carriers that comprises a list of QCL-TypeA resources, and each QCL-TypeA resource in the list of QCL-TypeA resources comprises a reference signal defined in a carrier of a list of carriers;
receive a medium access control control element message that activates a subset of the plurality of transmission configuration indicator states for use; and
receive a downlink control information signal that indicates a transmission configuration indicator state of the plurality of transmission configuration indicator states for a physical downlink shared channel, a physical downlink control channel, a physical uplink shared channel, a physical uplink control channel, or a combination thereof in a selected bandwidth part, a selected component carrier, or a combination thereof.

17. The processor of claim 16, wherein the transmission configuration indicator state comprises:
a QCL-TypeD resource applied to the physical downlink shared channel, the physical downlink control channel, or the combination thereof; or
a first quasi-co-location type resource applied to the physical downlink shared channel, the physical downlink control channel, the physical uplink shared channel, the physical uplink control channel, or some combination thereof.

18. The processor of claim 17, wherein the QCL-TypeA resource comprises a non-zero power channel state information reference signal resource.

19. The processor of claim 18, wherein the non-zero power channel state information reference signal resource is in a non-zero power channel state information reference signal resource set configured by a high layer parameter trs-info.

20. The processor of claim 17, wherein the at least one controller is configured to cause the processor to, in response to the transmission configuration indicator being applied for the component carrier, apply the QCL-TypeD resource or the first quasi-co-location type resource defined in the component carrier as spatial receive information for downlink reception in the component carrier.
